(19) United States
(12) Patent Application Publication
(10) Pub. No.: US 2022/0307537 A1
(43) Pub. Date: Sep. 29, 2022

(54) Assembly Improving, Low Mass, Fastener Head

(71) Applicant: MATHREAD INC., WIXOM, MI (US)

(72) Inventor: Michael Garver, Glen Arbor, MI (US)

(73) Assignee: MATHREAD INC., WIXOM, MI (US)

(21) Appl. No.: 17/214,358

(22) Filed: Mar. 26, 2021

(51) Int. Cl. F16B 23/00

(52) U.S. Cl. CPC F16B 23/003; F16B 23/0038; F16B 23/0092

(57) ABSTRACT

A low mass fastener head that reduces the amount of material required in manufacturing. The fastener comprises a threaded shank having a longitudinal axis; a head attached to one end of the threaded shank, the head comprising: full-height lugs and short-height lugs positioned at approximately 0, 60, 120, 180, 240, or 300 degrees around the longitudinal axis of the threaded shank, wherein the short-height lugs are shorter than the full-height lugs. Those portions of a hex head that are not necessary for application and transmission of torque, nor necessary to resist axial loading, nor necessary to axially stabilize the fastener head within conventional driving tooling may be removed. Compatibility with existing hex head tools is maintained while improving handling of the fastener by an assembler and reducing material used in the fastener head.

### TECHNICAL FIELD

The present disclosure relates to threaded fasteners, and more particularly, to an low mass fastener head having a relatively lower amount of material that is required in manufacturing the fastener, and having a fastener head geometry that is easier to handle.

### BACKGROUND

Currently in the fastener industry, the most common type of fastener head styles are the “Flanged hex head” and the “Hex head.” Referring to FIGS. 1(a) and 1(b), the “flanged hex head” and the “hex head are generally represented by the numerals 100a and 100b, respectively. These head styles both utilize a hex shaped head 102 for application of driving torque. The flanged hex head utilizes an integrated flange 104 at the base of the hex shaped head 102 to enhance application and distribution of the clamp-load of the fastener 100 caused by the engagement of the threads 106 with the internal threads of the work piece (not shown).

With common hex heads, only a very small portion of each facet of the hex may be utilized for torque application. This is due to the fact that the tool utilized to drive the hex head is also hex-shaped (some are twelve-sided or other variations). Because the tool's internal hex may be slightly larger dimensionally than the hex of the fastener (in order to slip over it freely), during initial driving the tool rotates slightly before it contacts the fastener hex (see FIGS. 2(a) and 2(b)).

When such contact is made, there may only initially be a “point” contact 208 between the corners 210 of the fastener hex 102 and the internal facet of the tool, viewed down the axis of the fastener as shown in FIG. 2. As torque application continues, local deformation of the fastener's hex corners 210 may result in this contact expanding to be more of a rectangular contact point between the internal facet of the tool and the deformed facet 314 of the fastener hex 102 shown in FIG. 3. A rectangular area 312 of the facet 316 varies in size and shape depending on fastener metallurgical properties, the amount of taper in the fastener 100, and the initial gap between a conventional box-end wrench or socket tool 220 and the facets 316 of the hex head 102. The area of this contact may be no more than ten percent of the surface area of each facet 316, and it may not extend beyond approximately ten percent from any corner of the hex head 102 (where facets 316 join together).

Similar contacts may be made during loosening of the fastener 100, e.g., rotational direction opposite tightening direction, except that this contact may occur on an area 314 of the opposite end of each hex facet 312. Therefore, the contact area 314 for loosening of the fastener 100 may be the mirror image of the tightening area 312, but is located at the opposite end of each facet 316 adjacent to each corner (where the facets 316 intersect). During installation and removal, the tool 220 may not contact the centers of the facets 316, and the area around the centers. Therefore, most of the surface areas of the hex head facets 316 may never be utilized and may not be necessary for either tightening or loosening the fastener 100.

The purpose of the application of torque to a hex-shaped fastener head is to revolve the fastener 100 axially, thus causing the thread helixes of the mating parts to engage.

Ultimately, the loading thusly applied is transmitted through the fastener 100 to its bearing surface, creating a spring-load in the fastened joint. Since only a small portion, e.g., facet portions 312 and 314 of the fastener hex head 102, are required, present technology fastener hex heads 102 contain much more material than required for this purpose, with that material located in places that are hardly ideal.

U.S. Pat. No. 8,747,044, incorporated herein in its entirety, discloses fastener heading having lower mass that is easier to handle and reduces the amount of material that is required in manufacturing. The fastener comprises three lugs at multiples of 60 degrees around an axis of a threaded body. Those portions of a hex head not necessary for application and transmission of torque, nor necessary to resist axial loading, nor necessary to axially stabilize the fastener head within current driving tooling may be removed. Compatibility with existing hex head tools is maintained while improving handling of the fastener by an assembler and reducing material used in the fastener head.

For some applications, prior art fasteners are heavier, more costly than necessary, and ill-suited for both hand and tool assembly. Some other prior technologies have addressed the phenomena of inefficient load application by creating special tools and driving surfaces, and other technologies have addressed material reduction by hollowing out the center of the hex head 102 through various means. Still other technologies have created three-cornered heads with special driving tools. None of these technologies have addressed the hex head 102 as a whole, considering the real current shape of the hex-head production part, as well as its interaction with tools in the industry. Current technology hex heads contain much more material than may be required for its intended purpose, and with material located in places that are hardly ideal for handling, and cost and weight reduction.

### SUMMARY

According to the teachings of this disclosure, a fastener head may need only enough material, placed in the appropriate positions, such that it is capable of resisting the applied torque without failure, and transmitting this torque to resist an axial load.

According to one aspect of the invention, a fastener comprises: a threaded shank having a longitudinal axis; a head attached to one end of the threaded shank, the head comprising: a first full-height corner defined by a first full tightening surface and positioned parallel to the longitudinal axis of the shank at approximately 0, 60, 120, 180, 240, or 300 degrees around the longitudinal axis of the threaded shank; a first short-height corner defined by a first short tightening surface and positioned at approximately 0, 60, 120, 180, 240, or 300 degrees around the longitudinal axis of the threaded shank; and wherein the first short-height corner is shorter than the first full-height corner.

According to another aspect of the invention, there is provided a fastener, comprising: a threaded shank having a longitudinal axis; a head attached to one end of the threaded shank, the head comprising: a first full-height lug comprising a tightening surface and positioned parallel to the longitudinal axis of the shank at approximately 0, 60, 120, 180, 240, or 300 degrees around the longitudinal axis of the threaded shank; a first short-height lug comprising a tightening surface and positioned at approximately 0, 60, 120, 180, 240, or 300 degrees around the longitudinal axis of the threaded shank; and wherein the first short-height lug is shorter than the first full-height lug.

### BRIEF DESCRIPTION OF THE DRAWINGS

A more complete understanding of the present disclosure may be acquired by referring to the following description taken in conjunction with the accompanying drawings wherein:

FIGS. 1(a) and 1(b) are schematic orthogonal diagrams of a prior technology flanged hex head and hex head fasteners;

FIGS. 2(a) and 2(b) are schematic plan diagrams of a prior technology hex head and tool used for rotation of the hex head;

FIG. 3 is a schematic orthogonal diagram of a prior technology hex head fastener showing contact areas for tightening and loosening the fastener;

FIG. 4A is a perspective view of a fastener head of the present invention having six lugs for engagement by a conventional box-end wrench or socket tool, wherein some lugs are taller than others;

FIG. 4B is a top view of the fastener head of FIG. 4A, where tightening and loosening surfaces are identified;

FIG. 4C is a side view of the fastener head of FIGS. 4A and 4B, wherein relative heights of lugs are shown;

FIG. 5 is a perspective view of a fastener head having two short lugs and four tall lugs;

FIG. 6 is a perspective view of a fastener head having a platform with a relatively smaller diameter and a hollowed-out or void interior portion;

FIG. 7 is a side view of a fastener having a head with short and tall lugs;

FIG. 8A is a perspective view of a fastener head of the present invention having six engagement surfaces defining corners for engagement by a conventional box-end wrench or socket tool, wherein some corners are taller than others; and

FIG. 8B is a side view of the fastener head of FIG. 8A, wherein relative heights of corners are shown.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawing, the details of specific example embodiments are schematically illustrated. Like elements in the drawings will be represented by like numbers, and similar elements will be represented by like numbers with a different lower case letter suffix.

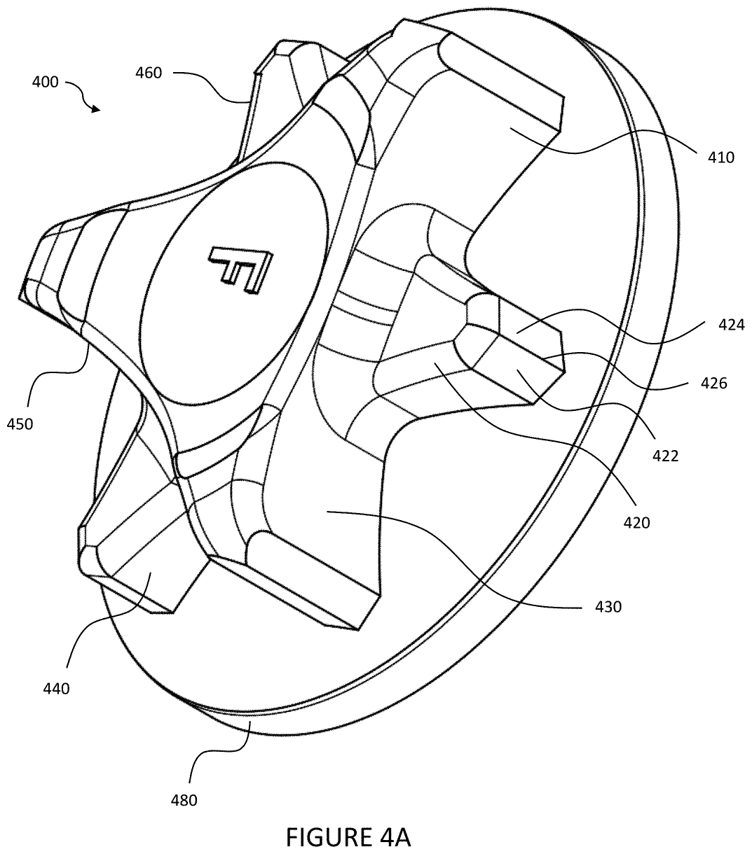

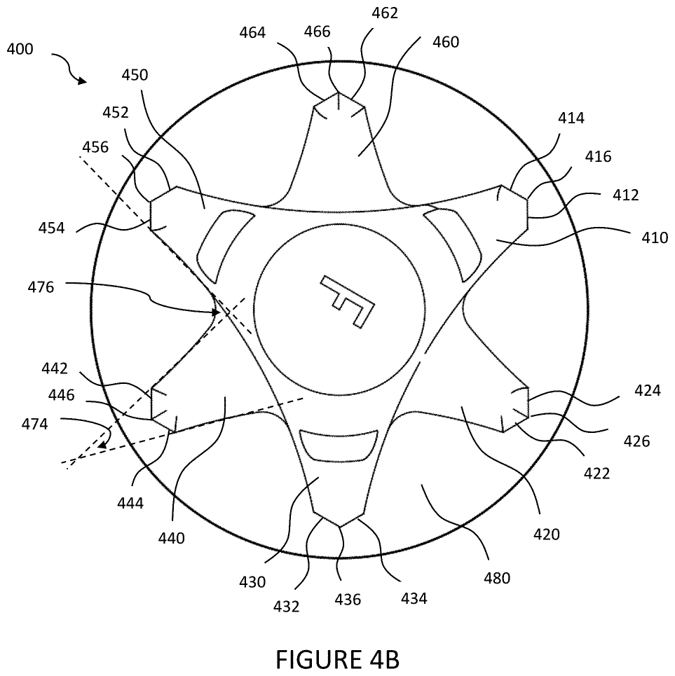

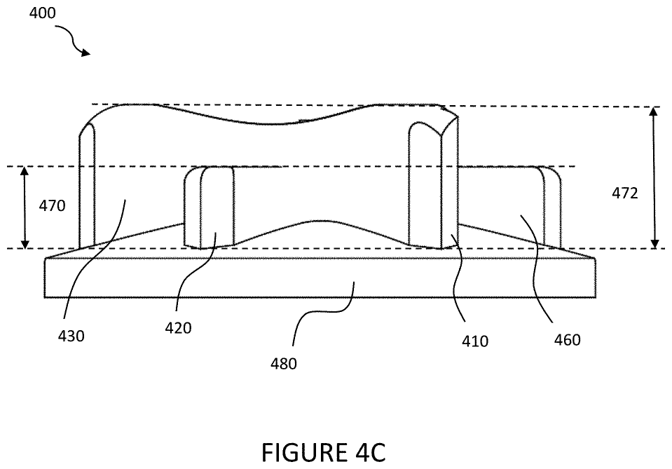

Referring to FIG. 4A, a perspective view of a fastener head of the present invention is illustrated. The head 400 head has six lugs 410, 420, 430, 440, 450, and 460 extending at 60-degree angles to each other from a central axis in a star-like fashion so that the lugs are located at positions approximately 0, 60, 120, 180, 240, or 300 degrees around the central axis of the fastener head.

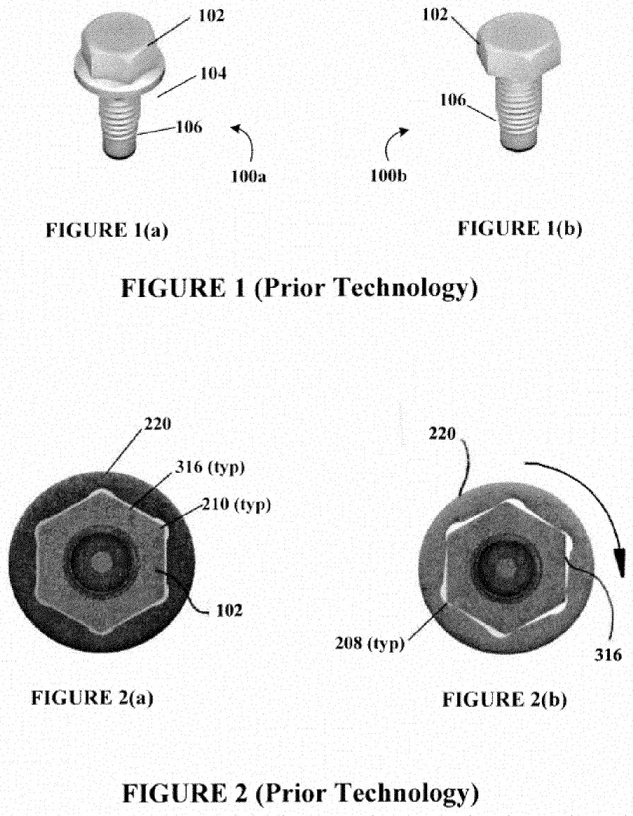

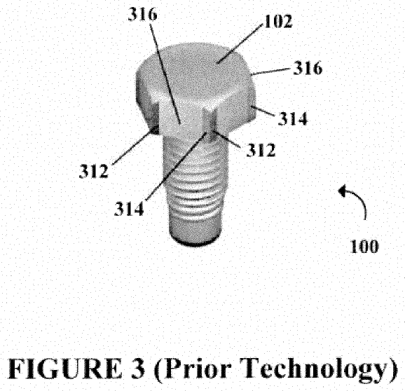

FIG. 4B shows a top view of the head 400 shown in FIG. 4A. Each lug has a tightening surface and a loosening surface with a corner between the surfaces. For example, lug 420 has a tightening surface 424 and a loosening surface 422 with a corner 426 between the surfaces. During fastening, contact between an external tool 220 (see FIGS. 1-3) and the fastener hex head 400 may take place via the tightening surfaces 414, 424, 434, 444, 454, and 464. During unfastening, contact between an external tool 220 (see FIGS. 1-3) and the fastener hex head 400 may take place via the loosening surfaces 412, 422, 432, 442, 452, and 462. It is contemplated and within the scope of this disclosure that such surface(s) may take any shape that efficiently provides adequate contact surfaces for standard tools, and/or may be significantly larger. One having ordinary skill in the art of designing and manufacturing fasteners and having the benefit of this disclosure would understand the benefits of an unlimited variety of shapes of the facet surfaces that may be employed in reducing the amount of material necessary in manufacturing the fastener while still maintaining compatibility with existing driver tools.

Tool contact on six planes stabilizes the fastener such that it does not rock appreciably during installation with known assembly tools, such as a conventional box-end wrench or socket tool. An assembly tool may be further stabilized by contact with a platform 480, from which the lugs 410, 420, 430, 440, 450, and 460 extend. The stability of the fastener relative to the tool may be influenced by the interaction of these planar surfaces 422 and 424 with the tool. Instability may occur if the angle of a plane is dramatically changed, e.g., by five or more degrees.

With further reference to FIG. 4B, angle 474 between the opposite sides of each lug 410, 420, 430, 440, 450, and 460 may be about thirty degrees)(30° and the angle 476 between sides of two adjacent lugs, for example lugs 440 and 450, may be about ninety degrees)(90° . However, in alternative embodiments, the angle 474 between the opposite sides of each lug may range between zero degrees)(0° and one hundred-twenty degrees) (120° . In other embodiments, the sides of each lug may be parallel. Still further, the sides may be angled in the other direction so that each lug is widest at the tightening and loosening surfaces, for example 424 and 422, and narrowest toward the center of the head 400. In other embodiments, each lug 410, 420, 430, 440, 450, and 460 may not be symmetrical, such that opposite sides of each lug may be at different angles relative to a center plane of the lug. Asymmetrical lugs may be advantageous where a fastener is intended to be tightened but not loosened, and in such a case less head material is needed to support the loosening surface than is needed to support the tightening surface. In some embodiments, the shapes of the lugs are not similar.

FIG. 4C shows a side view of the head 400 shown in FIGS. 4A and 4B. Three lugs 420, 440, and 460 are shorter in height than the other three lugs 410, 430, and 450. Height is defined as a distance from the platform 480 in a direction parallel to the central axis of the head 400. As shown in FIG. 4B, lugs 420, 440, and 460 have a height 470 and lugs 410, 430, and 450 have a height 472. Height 470 is shorter than height 472. Lugs 410, 430, and 450 with height 472 may provide full engagement with a conventional box-end wrench or socket tool 220 (see FIG. 2) and lugs 420, 440, and 460 with height 470 may provide partial engagement with an external socket tool 220. The lugs 420, 440, and 460 may be tall enough to stabilize a conventional box-end wrench or socket tool 220 and to provide structural features through which moment forces may be transmitted from the external socket tool 220 to a threaded shank of the fastener through the head 400. The shorter lugs 420, 440, and 460 may comprise less mass compared to the mass of the taller lugs 410, 430, and 450, which reduces the overall weight of the head 400 and reduces the amount of material needed to manufacture the head 400. Depending on the particular engineering parameters or specifications, the height 470 of the shorter lugs 420, 440, and 460 may be any height relative to the height 472 of the taller lugs 410, 430, and 450.

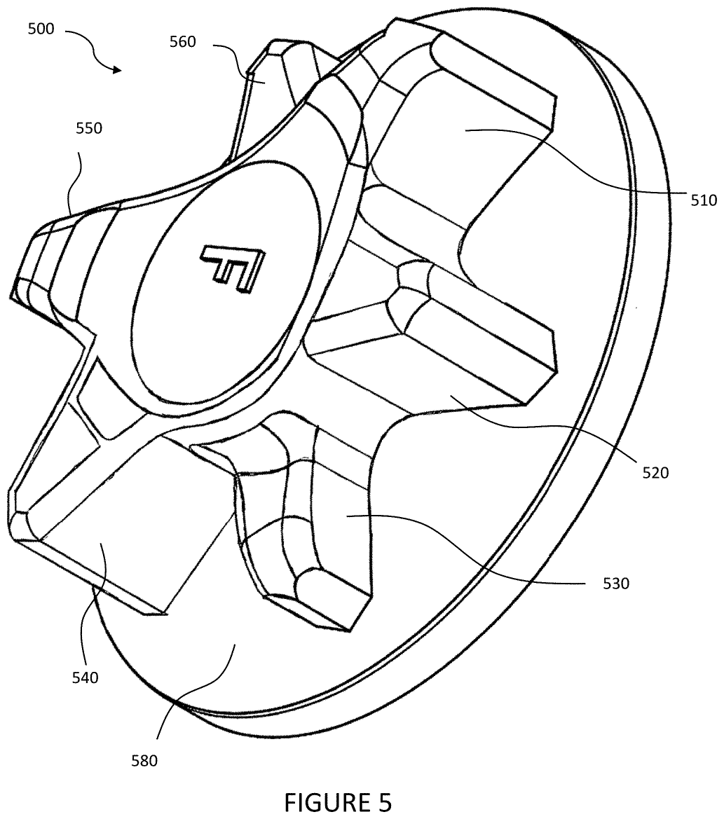

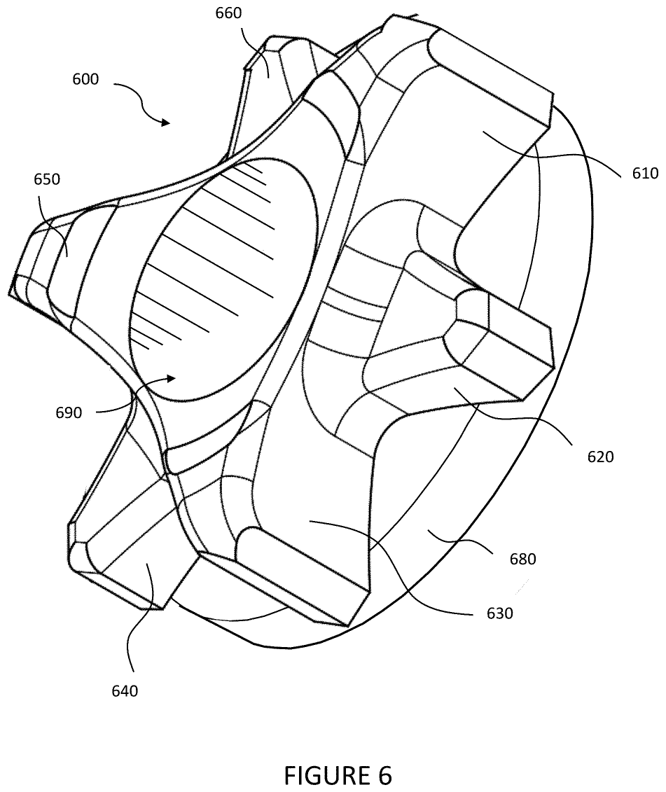

Referring to FIG. 5, a perspective view of a fastener head of the present invention is illustrated. The head 500 head has six lugs 510, 520, 530, 540, 550, and 560 extending at 60-degree angles to each other from a central axis in a star-like fashion. Lugs 510, 520, 540, and 550 are full-height lugs. Lugs 530 and 560 are shorter height lugs. Thus, in this illustrated embodiment, four of the lugs are full-height and two of the lugs are shorter-height.

Alternative embodiments of the invention have any number of short-height lugs and full-height lugs, arranged in any pattern. For example, the embodiment illustrated in FIG. 5, has a symmetrical pattern wherein short-height lugs 530 and 560 are opposite each other, and full-height lugs 510 and 520 are opposite full-height lugs 540 and 550. However, in asymmetric embodiments, short-height lugs and full-height lugs may be positioned for an asymmetric head pattern. For example lugs 510, 520 and 540 may be short-height lugs, and lugs 530, 550 and 560 may be full-height lugs. In another asymmetric example, only one of the six lugs is a short-height lug.

Referring now to FIG. 6, a perspective view of a fastener head 600 of the present invention is shown. As previously described, shorter lugs 620, 640, and 660 are located alternatingly between taller lugs 610, 630, and 650. Further, the platform 680 has a smaller diameter than other embodiments, such that the lugs extend radially out beyond the perimeter of the platform 680. In alternative embodiments, the platform may be any size relative to the lugs. In still further embodiments, a platform may be completely omitted.

The embodiment illustrated in FIG. 6 further shows a center portion of the head 600 being evacuated or void of material not substantially contributing to the functions stated hereinabove and/or for structural purposes. In particular, a hole 690 is formed in the center of the head 600. This may be done by utilizing any geometric shape which hollows out a center of the head, thus saving material and weight.

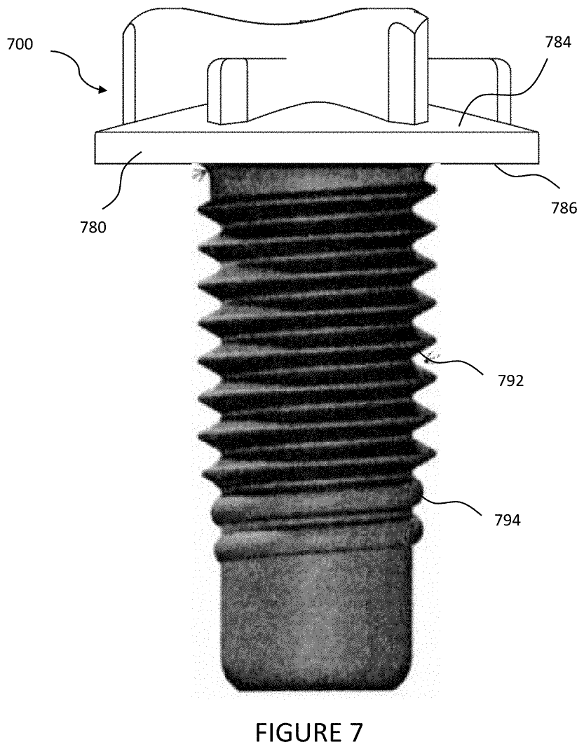

Referring to FIG. 7, a side-view schematic elevational diagram is shown of a fastener having a head 700 with a load-bearing platform 780 attached to a threaded shank 792. All of the above described features of the head, according to the teachings of this disclosure, may be incorporated in the head attached to the threaded portion of the fastener. In a specific example embodiment of this disclosure, the platform 780 may have a substantially cylindrical shape with a conical upper surface 784 that intersects the lugs of the fastener head 700. In a preferred construction, a lower surface 786 of the platform 780 may be slightly conical and may intersect with the thread body 792 in a radius. It is contemplated and within the scope of this disclosure, that the contour and conical nature of the top surface 784, the size and shape of the platform periphery, the angularity and contour of the lower surface 786, and the means of intersection with the thread body 792 may vary according to individually design requirements, as would be readily apparent to a person having ordinary skill in the art of threaded fastener design and having the benefit of this disclosure. The diameter of the cylindrical platform 780 may vary from a minimum determined by about a diameter of the fastener shank 792, to a maximum of about two times the shank's diameter. In some embodiments, the diameter of the cylindrical platform 780 may be larger than a circle circumscribed by the corners of the lugs.

The platform 780 may be thick enough so as to be capable of resisting the design loads associated with the threaded shank 792 without failure, however, it is contemplated herein and within the scope of this disclosure that it may be much thicker as determined by individual design requirements.

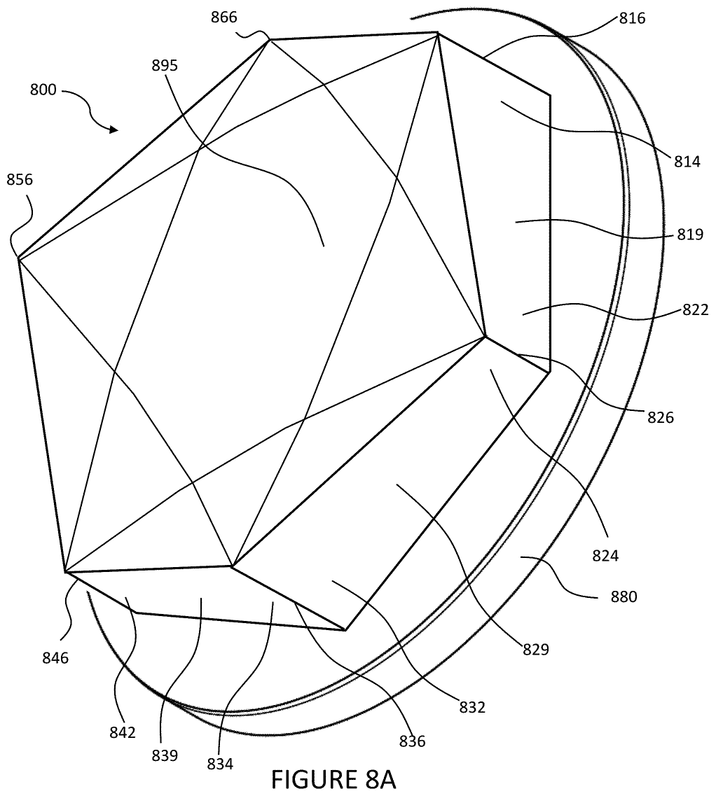

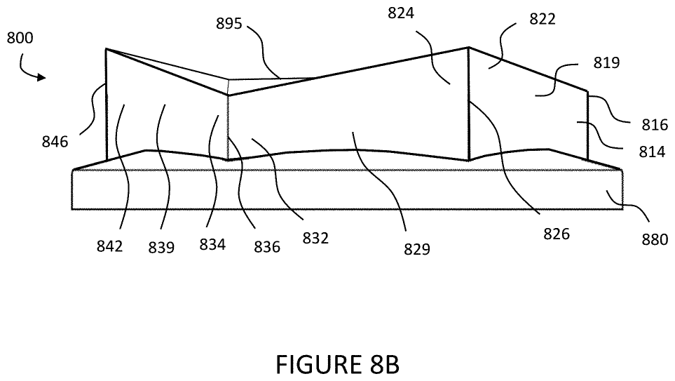

FIGS. 8A and 8B illustrate perspective and side views, respectively, of a fastener head of the present invention. The head 800 has a platform 880 and six engagement surfaces in the shape of a hexagon. For example, engagement surface 819 comprises tightening surface 822 adjacent corner 826 and loosening surface 814 adjacent corner 816, so that it is one continuous surface extending from corner to corner. The other five engagement surfaces similarly comprise tightening and loosening surfaces. The six engagement surfaces meet at corners 816, 826, 836, 846, 856, and 866. In the illustrated embodiment, corners 816, 836, and 856 are full-height, and corners 826, 846, and 866 are short-height. In alternative embodiments, at least one corner is full-height and at least one corner is short-height, and the other corners may be any height between short-height and full-height. As with the embodiment shown in FIG. 6, this embodiment may also have a center portion of the head 800 being evacuated or void of material not substantially contributing to the functions stated hereinabove and/or for structural purposes. In the illustrated example, a top central surface 895 has a height that is shorter than the full-height corners 816, 836, and 856, such that less material is needed to form the head because the top central surface 895 is shorter. In a further embodiment, a hole may be formed in the center of the head 800. This may be done by utilizing any geometric shape which hollows out a center of the head, thus saving material and weight. Further, the platform 880 may be any size or shape and may be completely omitted from the head 800.

It is contemplated herein and within the scope of this disclosure that substantially all current thread designs and point styles may be used in combination with the fastener head disclosed hereinabove, particularly standard threads as described in international standards such as ISO and IFI. Of particular effectiveness in improving assembly efficiency is the integration of the head style, according to the teachings of this disclosure, with anti-cross thread designs 794, as shown in FIG. 7, and more fully described in U.S. Pat. Nos. 5,730,566; 5,791,849; 5,836,731; 5,997,231; and 6,162,001; all of which are incorporated by reference herein for all purposes, and marketed under the trade names MAThread® and MATpoint® (Registered trademarks of MAThread, Inc., 28061 Grand Oaks Court, Wixom, Michigan 48393) and other similar designs.

A process for manufacturing bolts, in particular bolt heads, involves pressing metal blanks into a die. As a metal blank is pressed into a die, the metal flows into the deepest crevices and corners of the die to form the most distal end portions of the lugs of the head which are farthest away from the platform. The hallowed out portions of the heads between the lugs illustrated in this disclosure may be formed by dies that displace metal from the center of the head outwardly toward the distal portions of the lugs. Of course, the shape of the central portion of the die defines in reverse the shape of the hallowed out central portion of the head. The shape of the central portion of the die, and thus the shape of the hallowed out central portion of the head may take any shape. As shown in FIG. 6, the shape is cylindrical. Alternatively, the shape may somewhat triangular or trilobular, hexagonal, square, or any other shape. A hallowed out portion that is hexagonal may be advantageous as it allows the metal from the blank to flow evenly and completely to form the most distal portions of the lugs extending from the platform.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

what is claimed is:

1. A fastener, comprising:
a threaded shank having a longitudinal axis;
a head attached to one end of the threaded shank, the head comprising:
a first full-height tightening surface positioned parallel to the longitudinal axis of the shank at approximately 0, 60, 120, 180, 240, or 300 degrees around the longitudinal axis of the threaded shank;
a first short-height tightening surface positioned at approximately 0, 60, 120, 180, 240, or 300 degrees around the longitudinal axis of the threaded shank; and
wherein the first short-height tightening surface is shorter than the first full-height tightening surface.

2. The fastener according to claim 1, further comprising: a first full-height loosening surface wherein the first full-height tightening surface and the first full-height loosening surface define a first full-height corner; and a first short-height loosening surface wherein the first short-height tightening surface and the first short-height loosening surface define a first short-height corner.

3. The fastener according to claim 1, further comprising a second full-height tightening surface positioned parallel to the longitudinal axis of the shank at approximately 0, 60, 120, 180, 240, or 300 degrees around the longitudinal axis of the threaded shank.

4. The fastener according to claim 3, further comprising a second short-height tightening surface positioned parallel to the longitudinal axis of the shank at approximately 0, 60, 120, 180, 240, or 300 degrees around the longitudinal axis of the threaded shank, and wherein the second short-height tightening surface is shorter than the first full-height tightening surface.

5. The fastener according to claim 4, further comprising: a second full-height loosening surface wherein the second full-height tightening surface and the second full-height loosening surface define a second full-height corner; and a second short-height loosening surface wherein the second short-height tightening surface and the second short-height loosening surface define a second short-height corner.

6. The fastener according to claim 3, further comprising a third full-height tightening surface positioned parallel to the longitudinal axis of the shank at approximately 0, 60, 120, 180, 240, or 300 degrees around the longitudinal axis of the threaded shank.

7. The fastener according to claim 4, further comprising a third short-height third tightening surface positioned parallel to the longitudinal axis of the shank at approximately 0, 60, 120, 180, 240, or 300 degrees around the longitudinal axis of the threaded shank, and wherein the third short-height tightening surface is shorter than the first full-height tightening surface.

8. The fastener according to claim 7, further comprising: a third full-height loosening surface wherein the third full-height tightening surface and the third full-height loosening surface define a third full-height corner; and a third short-height loosening surface wherein the third short-height tightening surface and the third short-height loosening surface define a third short-height corner.

9. The fastener according to claim 6, wherein the first, second, and third full-height tightening surfaces are substantially the same height.

10. The fastener according to claim 7, wherein the first, second, and third short-height tightening surfaces are substantially the same height.

11. The fastener according to claim 1, wherein the head further comprises a platform, wherein the platform is attached to the threaded shank.

12. The fastener according to claim 1, further comprising a top central surface that is shorter than the first full-height tightening surface.

13. A fastener, comprising:
a threaded shank having a longitudinal axis;
a head attached to one end of the threaded shank, the head comprising:
a first full-height lug positioned parallel to the longitudinal axis of the shank at approximately 0, 60, 120, 180, 240, or 300 degrees around the longitudinal axis of the threaded shank;
a first short-height lug positioned at approximately 0, 60, 120, 180, 240, or 300 degrees around the longitudinal axis of the threaded shank; and
wherein the first short-height lug is shorter than the first full-height lug.

14. The fastener according to claim 13, further comprising a second full-height lug positioned parallel to the longitudinal axis of the shank at approximately 0, 60, 120, 180, 240, or 300 degrees around the longitudinal axis of the threaded shank.

15. The fastener according to claim 13, further comprising a second short-height lug positioned parallel to the longitudinal axis of the shank at approximately 0, 60, 120, 180, 240, or 300 degrees around the longitudinal axis of the threaded shank, and wherein the second short-height lug is shorter than the first full-height lug.

16. The fastener according to claim 14, further comprising a third full-height lug positioned parallel to the longitudinal axis of the shank at approximately 0, 60, 120, 180, 240, or 300 degrees around the longitudinal axis of the threaded shank.

17. The fastener according to claim 15, further comprising a third short-height lug positioned parallel to the longitudinal axis of the shank at approximately 0, 60, 120, 180, 240, or 300 degrees around the longitudinal axis of the threaded shank, and wherein the third short-height lug is shorter than the first full-height lug.

18. The fastener according to claim 13, wherein sides of at least two adjacent lugs form an angle of at least 90 degrees.

19. The fastener according to claim 13, wherein opposite sides of at least one lug form an angle of at least 30 degrees.

20. The fastener according to claim 13, further comprising a top central surface that is shorter than the first full-height lug.
